(19) United States
(12) Patent Application Publication
(10) Pub. No.: US 2003/0116223 A1
(43) Pub. Date: Jun. 26, 2003

(54) Moulding apparatus

(76) Inventor: Pieter Wouter Du Toit, Northern Paarl (ZA)

Correspondence Address: LADAS & PARRY, 26 WEST 61ST STREET, NEW YORK, NY, 10023, US

(21) Appl. No.: 10/181,877

(22) PCT Filed: Jan. 19, 2001
(86) PCT No.: PCT/ZA01/00004

(30) Foreign Application Priority Data
Jan. 21, 2000 (ZA) 2000/0254

(51) Int. Cl. B67C 3/34; B67C 3/26

(52) U.S. Cl. 141/259

(57) ABSTRACT

Moulding apparatus is disclosed in which a charge of the material to be moulded is fed into a holding cavity. The holding cavity is then shifted to a second position, and a plunger forces the charge out of the holding cavity into the moulding cavity. The holding cavity has a movable wall, preferably the front surface of a piston, the position of which wall can be varied so that the volume of the holding cavity can be changed to suit the volume of the cavity of the mould being used.

### FIELD OF THE INVENTION

THIS INVENTION relates to moulding apparatus.

### BACKGROUND TO THE INVENTION

In the specification of PCT application No. PCT/US97/15673 (published as WO98/09786) there is disclosed a method of moulding which comprises filling a holding cavity with a charge of mouldable material, transferring the holding cavity from the location at which it was filled to a second location, and using a plunger to force the charge out of the holding cavity and into a mould cavity. Apparatus for performing the method is also disclosed.

The apparatus does not include narrow gates, sprues and runners and hence can be used to mould filled synthetic plastics, that is, synthetic plastics with fibres dispersed therein. Conventional injection moulders, because they include such gates, runners and sprues can only be used with short fibres. Any attempt to use longer fibres, and thus improve the characteristics of the component, results in the runners etc being blocked.

Experimental work with the apparatus of WO98/09786 has shown that it has a limitation in that the volume of the holding cavity is fixed. This is not a problem if the apparatus is to be used to make a single product requiring a fixed volume of plastics material and filler. It does mean, however, that replacement of those parts of the apparatus which bound the holding cavity must be undertaken if a part of a different volume is to be made using the apparatus.

### BRIEF DESCRIPTION OF THE INVENTION

According to one aspect of the present invention there is provided moulding apparatus comprising a holding cavity, means for delivering a charge of mouldable material to the holding cavity, means for displacing the holding cavity between the position at which it is filled and a further position at which the charge of material is displaced out of the holding cavity into a mould cavity, a plunger for displacing said charge from the holding cavity into the mould cavity, a piston forming part of the bounding wall of the holding cavity, the piston being displaceable between a forward position which it occupies whilst the holding cavity is being filled and a retracted position to which it is withdrawn to permit the holding cavity to be displaced between said positions, and means for varying the location of said forward position thereby to enable the volume of the holding cavity to be varied.

According to a further aspect of the present invention there is provided a method of moulding which comprises delivering a charge of mouldable material into a holding cavity whilst the holding cavity is in a filling position, the holding cavity having a movable wall, said holding cavity being filled by material delivered thereto whilst the wall is in a forward position thereby to fill the holding cavity, the location of said forward position being adjustable thereby to enable the volume of the holding cavity to be varied, withdrawing said wall to a retracted position, displacing said holding cavity from the filling position to a discharge position, and discharging the mouldable material from the holding cavity into a mould cavity by means of a plunger.

According to a still further aspect of the present invention there is provided moulding apparatus which has a first barrel having a first piston displaceable in it between a retracted position and a forward position, the first barrel having an open end for connection to a mould cavity, a second barrel opening into the first barrel through the cylindrical bounding wall thereof, a second piston in the second barrel and displaceable between a retracted position and a forward position in which forward position its front face is coincident with and forms part of the bounding wall of said first barrel, and means for feeding a charge of mouldable material of predetermined volume to said second barrel between the position to which the second piston retracts and the intersection between the first and second barrels.

According to another aspect of the present invention there is provided a method of moulding which comprises feeding a measured charge of a mouldable material into a first barrel, advancing a piston to urge said mouldable material along the first barrel and into a second barrel with which the first barrel intersects, and advancing a second piston along the second barrel to urge the mouldable material into a mould cavity.

Said mould cavity is closed by the time the second piston urges mouldable material into it, and the second piston exerts the requisite moulding pressure on the mouldable material to fill the mould cavity.

### BRIEF DESCRIPTION OF THE DRAWINGS

For a better understanding of the present invention and to show how the same may be carried into effect, reference will now be made, by way of example, to the accompanying drawings in which:

FIGS. 1 to 6 diagrammatically illustrate the operation of a first embodiment of moulding apparatus in accordance with the present invention;

FIG. 7 is a pictorial view of a further form of moulding apparatus;

FIG. 8 is a similar pictorial view, to a smaller scale, showing the apparatus in a different operative position;

FIG. 9 is a side elevation of the apparatus;

FIG. 10 is a transverse section through the apparatus; and

FIG. 11 is a section diagrammatically illustrating a further form of moulding apparatus in accordance with the present invention.

### DETAILED DESCRIPTION OF THE DRAWINGS

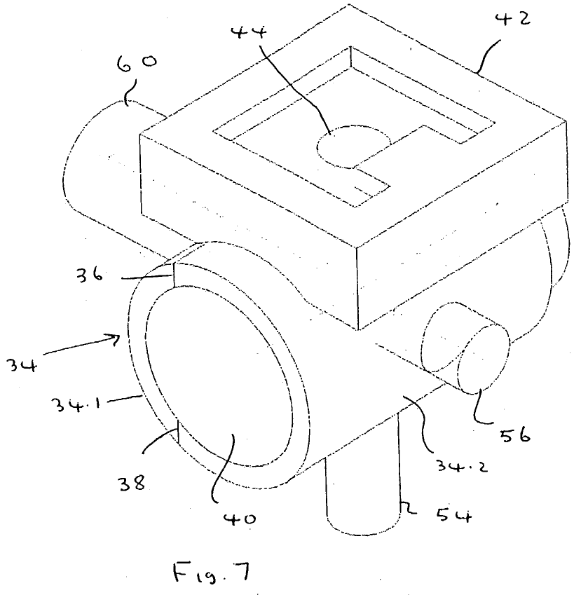

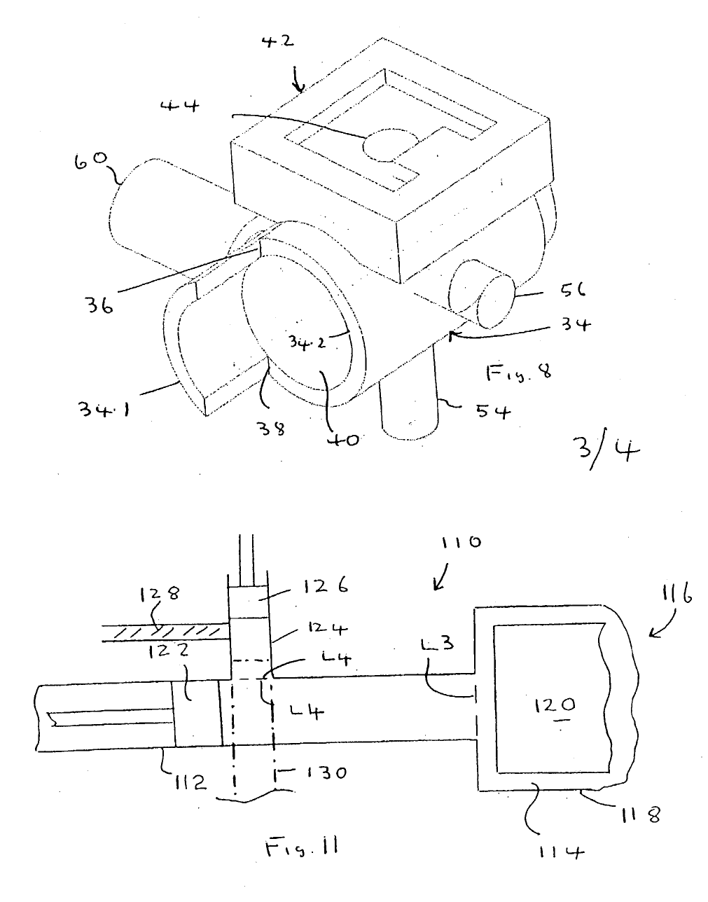

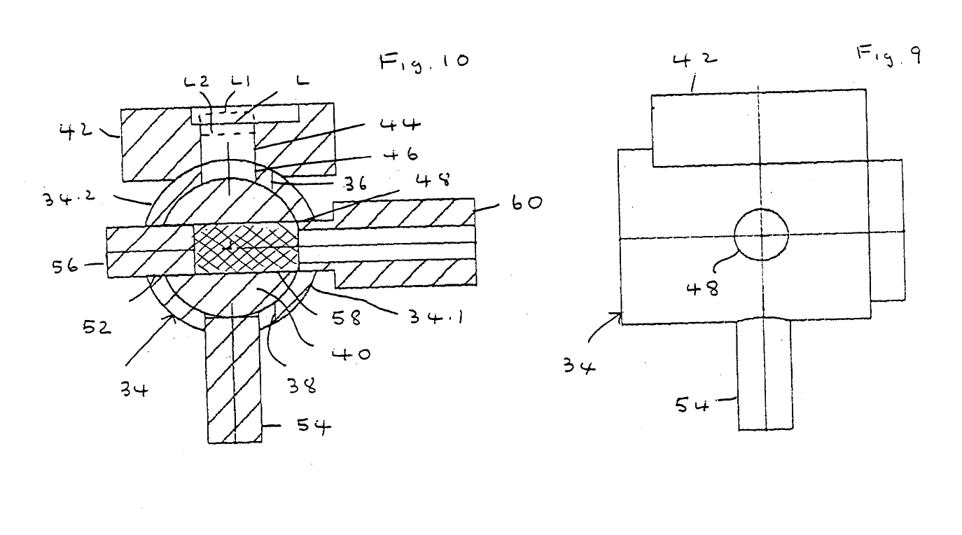

Referring firstly to FIGS. 1 to 6, the apparatus 10 illustrated comprises three plates 12, 14 and 16. The centre plate 14 is movable with respect to the other two and has a holding cavity 18 which is constituted by a passage which passes through the plate 14. The plate 12 is fixed and carries an extruder 20 which is displaceable with respect to the holding cavity 18 between the positions of FIGS. 1, 2 and 4. The plate 16 is also fixed and has a passage 22 therethrough. A piston 24 (shown hatched) is carried by the plate 16. The piston 24 is free to move in the passage 22 between a forward position (FIGS. 3 and 4) and a retracted position (FIGS. 1, 2, 5 and 6). In the retracted position the front face 24.1 of the piston is flush with the face of the plate 16. The position to which the piston 24 advances can be adjusted thereby to enable the volume of the holding cavity 18 to be varied. The further into the passage constituting the holding cavity 18 that the piston 24 is advanced, the smaller the volume of the holding cavity that is available for filling.

A plunger 26 (only shown in FIGS. 5 and 6) is provided for discharging the charge of material from the holding cavity and into a mould cavity designated 28. The plate 12 has an opening 30 (FIGS. 5 and 6) in it which communicates with the mould cavity 28.

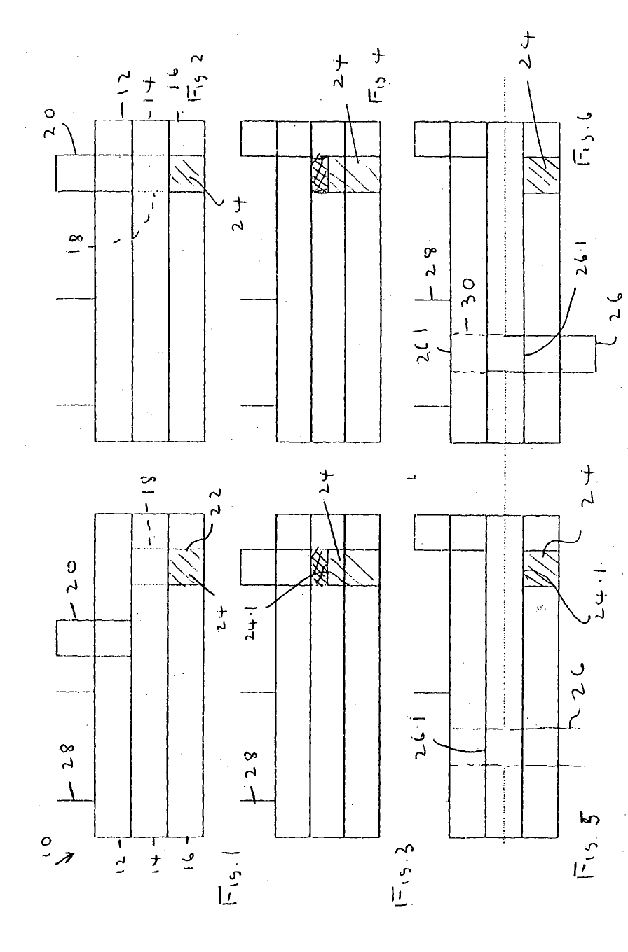

The sequence of operations is as follows. The extruder 20 is displaced to a position in which it is aligned with the holding cavity 18 (FIG. 2). The piston 24 is advanced into the holding cavity 18 (FIG. 3) until the holding cavity has the same volume as the mould cavity 28. The volume of the holding cavity is shown double hatched in FIGS. 3 and 4. The extruder 20 then delivers a charge of synthetic plastics to the cavity 18 and fills the available volume (see FIG. 3). The extruder 20 is then moved out of alignment with the holding cavity (FIG. 4). The mould cavity was closed immediately after the previously moulded component was ejected.

The piston 24 is withdrawn to the position in which its front face 24.1 is flush with the plate 16 (see FIGS. 5 and 6). Thereafter, the plate 14 is displaced until the holding cavity is aligned with the plunger 26, the opening 30 and the mould cavity 28. The plunger 26 is then advanced to a position in which its front face 26.1 is flush with the surface of the plate 12 and becomes part of the bounding wall of the mould cavity 28. As the plunger 26 moves it forces the material into the cavity 28.

It will be noted that the cross sectional area of the plunger 26 is equal to that of the cavity 18 and that the cross sectional area of the passage constituting the holding cavity 18 is constant throughout its length. It is also equal in area to the opening 30 which places the holding cavity 18 in communication with the mould cavity 28.

Should it be desired to change the mould and use a mould of different volume, the volume of the holding cavity can be changed by advancing the piston 24 more or less into the passage constituting the holding cavity 18.

Turning now to FIGS. 7 to 10, the apparatus 32 illustrated comprises an outer sleeve 34 which is split along the lines 36, 38 into two sleeve parts 34.1, 34.2. The part 34.1 is about 60 degrees in circumferential extent. A shaft 40 is fitted into the sleeve 34 and is free to perform rotary oscillations therein.

One part of a mould is shown at 42, the mould part which fits on the part 42 being omitted from FIGS. 7 and 8 to show the opening 44 through which the mouldable material enters the mould.

Referring now specifically to FIG. 10, the sleeve 34 has in it four ports 46, 48, 50 and 52. The port 46 registers with the opening 44 and the port 50 is diametrically opposed to the port 46. A plunger 54 fits in the port 50.

A piston 56 fits in the port 52 which is diametrically opposed to the port 48. The ports 48, 52 are placed in communication with one another by a passageway 58 which extends diametrically through the shaft 40. An extruder for feeding mouldable material to the passageway 58 is diagrammatically shown at 60 and feeds mouldable material into the passageway 58 through the port 48. It will be noted that the extruder 60 is carried by the smaller sleeve part 34.1. As illustrated in FIGS. 7 and 8, the extruder 60 and sleeve part 34.1 can slide axially with respect to the sleeve part 34.2.

Whilst the moulding apparatus is as shown in FIG. 10, the plunger 54 is in a forward position and in a predetermined location in the passageway 58. The passageway 58 constitutes a holding cavity. The volume of the cavity is denoted by the criss-cross hatching. If the plunger 54 is moved further to the right the volume of the cavity decreases and if it is moved to the left the volume of the cavity increases. The extruder 60 packs the holding cavity with mouldable material.

Once the cavity is packed, the sleeve part 34.1 and the extruder 60 slide from the position shown in FIG. 7 to the position shown in FIG. 8. The extruder thus moves out of alignment with the passageway 58 and the right hand end of the passageway (as viewed in FIG. 10) is blocked-off by the sleeve part 34.1

The next stage in the moulding procedure is withdrawal of the plunger 50 until its front face is flush with the inner surface of the sleeve 34. The volume of the holding cavity thus increases but no further material enters it because the extruder is out of alignment with the passageway 58. The shaft 40 is now free to rotate through a quarter turn (90 degrees) to bring the passageway 58 into alignment with the ports 46 and 50:

The plunger 54 is then advanced from the retracted position illustrated to a forward position in which its front face 54.1 forms part of the bounding surface of the mould cavity. The position of the front face once the plunger 54 has been advanced depends on the configuration of the front face and the shape of the mould. For example it could lie along line L (FIG. 10) so that the article moulded has a flat lower surface. If the moulded article is to have a circular depression then the face can advance to L1. If the moulded article is to have a protrusion then the front face can be at L2.

In the form illustrated in FIGS. 7 to 10 the part 34.1 and extruder 60 move after the holding cavity has been packed. To make it unnecessary to move the extruder a shut-off device can be provided which closes when the cavity is full or alternatively back pressure can be used to stop the extruder screw.

The apparatus 110 illustrated in FIG. 11 comprises a main barrel 112 which, at its forward end, opens directly into the cavity 114 of a mould 116. The mould 116 comprises a female mould member 118 and a male mould member 120 which together bound the cavity 114.

A piston 122 Is located in the barrel 112. There are means (not shown) for displacing the piston 122 in the forward and return strokes between the retracted position illustrated and a forward position in which the front face of the piston lies along the line L3. The front face of the piston thus forms part of the bounding surface of the mould cavity.

The barrel 112 is of constant cross-section throughout its length.

A subsidiary barrel 124 enters the main barrel 112 through the side wall thereof.

The axis of the barrel 124 can be vertical and the barrel 124 can be above the barrel 112, or the barrel 124 can be horizontal and have its longitudinal axis in the same horizontal plane as the axis of the barrel 112. A subsidiary piston 126 is provided in the barrel 124 and can be displaced from the retracted position illustrated to a forward position where its front face is at L4. The front face of the piston 126 is shaped so that it matches the shape of the surface of the barrel 112. Thus it has a curved surface the radius of which is the same as that of the barrel 112. Once the piston 126 is in its forward position the surface of the barrel 112 is smooth and continuous through its length.

An extruder screw 128 enters the barrel 124 through the side wall thereof. The extruder screw 128 is of any commercially available type which is capable of delivering an accurately measured quantity of mouldable material, usually synthetic plastics material, to the barrel 124.

The barrels 112 and 124 have heating bands (not shown) around them to ensure that the plastics material remains molten.

In operation the extruder screw 128 feeds mouldable material into the barrel 124. If the barrel 124 is vertical all or some of the material falls into the barrel 112. If the barrel 124 is horizontal then the material lies in it. Once the extruder screw 128 has fed in the predetermined quantity of mouldable material, the piston 126 advances urging the material ahead of it into the barrel 112. The piston 126 stops when its front face is at L4 and thus coincident with the surface of the barrel 112.

The piston 122 then advances to push the mouldable material into the cavity 114, the front face of the piston 122 preferably stopping at L3. However, as explained in relation to lines L1 and L2 above, this is not essential and the front face of the piston 122 could be in front of, or behind, the line L3.

The mould 116 and piston 122 have cooling channels (not shown). As soon as the front face of the piston 122 is at L3, cooling fluid is fed through the channels to solidify the mouldable material. At the end of the cooling cycle the mould opens and the component produced is ejected. The pistons 112 and 126 retract to commence another cycle. To reduce cycle time the pistons can retract simultaneously but the extruder screw 128 is not activated until the piston 122 has retracted beyond the zone where the barrels intersect. Because the piston 122 can be cooled to the same temperature as the mould, the piston 122 does not leave the type of mark on the component that can be produced when the component is contacted by parts which are at different temperatures.

The mould can close before the piston 122 commences a forward stroke, or after the forward stroke has commenced. If the mould is fully closed before the mouldable material reaches the cavity 114, it is the piston 122 which exerts the moulding pressure. If the mould is not fully closed by the time the material reaches the cavity, moulding pressure can be achieved by the clamping action of the mould parts.

If it is desired that the measured volume be achieved by packing a cavity rather than using an extruder which delivers a measured amount of mouldable material, a further plunger 130 can be provided as shown by the chain dotted lines. This plunger can be moved between a retracted position in which its part cylindrical front face is co-incident with the wall of the barrel 112 diametrically opposed to the barrel 124 and a forward position in which said front face is within the barrel 124. This provides a holding cavity between the plunger 130 and the piston 126 which can be packed. Adjusting the position of either piston 126 or plunger 130, or both, can be used to vary the volume of the holding cavity.

1. Moulding apparatus comprising a holding cavity, means for delivering a charge of mouldable material to the holding cavity, means for displacing the holding cavity between the position at which it is filled and a further position at which the charge of material is displaced out of the holding cavity into a mould cavity, a plunger for displacing said charge from the holding cavity into the mould cavity, a piston displaceable between a forward position which it occupies whilst the holding cavity is being filled and a retracted position to which it is withdrawn to permit the holding cavity to be displaced between said positions, and means for varying the location of said forward position thereby to enable the volume of the holding cavity to be varied.

2. Apparatus according to claim 1, and which comprises a shaft having a passageway which extends diametrically through it, the passageway constituting the holding cavity, a cylindrical sleeve, said shaft being in said sleeve, a first port in the sleeve for connecting the holding cavity to a mould cavity, a second port which is diametrically opposed to the first port, third and fourth diametrically opposed ports which are circumferentially displaced from the first and second ports, means for rotating the shaft and sleeve relatively to one another between a first position in which the holding cavity is aligned with the first and second ports and a second position in which it is aligned with the third and fourth ports, said plunger entering the holding cavity through the second port, the piston entering the holding cavity through the third port, there being means for filling the holding cavity through the fourth port.

3. Apparatus according to claim 2, wherein said means rotates said shaft in the sleeve between said positions.

4. A method of moulding which comprises delivering a charge of mouldable material into a holding cavity whilst the holding cavity is in a filling position, the holding cavity having a movable wall, said holding cavity being filled by material delivered thereto whilst the wall is in a forward position, the location of said forward position being adjustable thereby to enable the volume of the holding cavity to be varied, withdrawing said wall to a retracted position, displacing said holding cavity from the filling position to a discharge position, and discharging the mouldable material from the holding cavity into a mould cavity by means of a plunger.

5. Moulding apparatus which has a first barrel having a first piston displaceable in it between a retracted position and a forward position, the first barrel having an open end for connection to a mould cavity, a second barrel opening into the first barrel through the cylindrical bounding wall thereof, a second piston in the second barrel and displaceable between a retracted position and a forward position in which forward position its front face is coincident with and forms part of the bounding wall of said first barrel, and means for feeding a charge of mouldable material of predetermined volume to said second barrel between the position to which the second piston retracts and the intersection between the first and second barrels.

6. A method of moulding which comprises feeding a measured charge of a mouldable material into a first barrel, advancing a piston to urge said mouldable material along the first barrel and into a second barrel with which the first barrel intersects, and advancing a second piston along the second barrel to urge the mouldable material into a mould cavity.

7. A method claimed in claim 6, wherein said mould cavity is closed by the time the second piston urges mouldable material into it, and the second piston exerts moulding pressure on the mouldable material to fill the mould cavity.
